(19) United States
(12) Patent Application Publication
(10) Pub. No.: US 2006/0103320 A1
(43) Pub. Date: May 18, 2006

(54) Holiday Light String Devices

(75) Inventor: John L. Janning, Dayton, OH (US)

Correspondence Address: Robert L. Clark, 3033 S. Kettering Blvd, STE 210, Dayton, OH, 45439, US

(73) Assignee: JLJ, INC., Dayton, OH (US)

(21) Appl. No.: 11/307,754

(22) Filed: Feb. 21, 2006

Related U.S. Application Data
(60) Provisional application No. 60/688,575, filed on Jun. 8, 2005.
(60) Provisional application No. 60/755,903, filed on Jan. 3, 2006.

(51) Int. Cl. H05B 37/00

(52) U.S. Cl. 315/164

(57) ABSTRACT

Bi-polar same-color LED devices are described comprising at least a pair of substantially same-color light emitting diodes connected in inverse parallel. The devices are advantageously used in AC powered light strings, e.g., connected in series blocks. Parallel block interconnections of the devices in an AC powered light string are also possible, e.g., where a parallel block of devices is connected in series with other elements in the string. The devices may be used in light strings with or without various current limiting circuits.

### CROSS-REFERENCE TO RELATED APPLICATIONS

Benefit of priority is claimed based on U.S. Provisional Application No. 60/688,575 filed Jun. 8, 2005, titled “LED Light String;” and U.S. Provisional Application No. 60/755,903 filed Jan. 3, 2006, titled “AC Powered LED Light String.”

### BACKGROUND

LED light strings are commonly used for Christmas or other holiday season lighting. Examples are DC or pulsed-DC powered light strings, e.g., based on standard 120 VAC household power which is converted or rectified. Series-wired AC powered LED light strings are also used, dispensing with power conversion and rectification circuits. Such series-wired strings can fail if one LED lighting element fails and care must typically be taken to correctly orient the polarity of each LED for the light strings to operate. Also, as LEDs are typically polar DC devices, an LED only conducts during half of an AC cycle. LEDs have advantages compared with incandescent bulbs, e.g., higher efficiency and longer life.

### SUMMARY

Bi-polar same-color LED devices are described comprising at least a pair of substantially same-color light emitting diodes connected in inverse parallel. The devices are advantageously used in AC powered light strings, e.g., connected in series blocks. Parallel block interconnections of the devices in an AC powered light string are also possible, e.g., where a parallel block of devices is connected in series with other elements in the string. The devices may be used in light strings with or without various current limiting circuits.

Advantages, variations and other features of the invention will become apparent from the drawings, the further description of examples and the claims to follow.

### BRIEF DESCRIPTION OF THE DRAWINGS

FIG. 1 shows a circuit schematic of a bi-polar same-color LED device.

FIG. 2 shows a circuit schematic of bi-polar same-color LED devices in a series-wired block in an AC powered light string.

FIG. 3 shows a circuit schematic of bi-polar same-color LED devices in a parallel block in series with other lighting elements in an AC powered light string.

FIG. 4 shows a circuit schematic of bi-polar same-color LED devices in a series-wired block in an AC powered light string with exemplary current limiting circuitry.

FIG. 5 shows a circuit schematic of bi-polar same-color LED devices in a series-wired block in an AC powered light string with an incandescent flasher bulb device.

### DESCRIPTION OF PREFERRED EMBODIMENTS

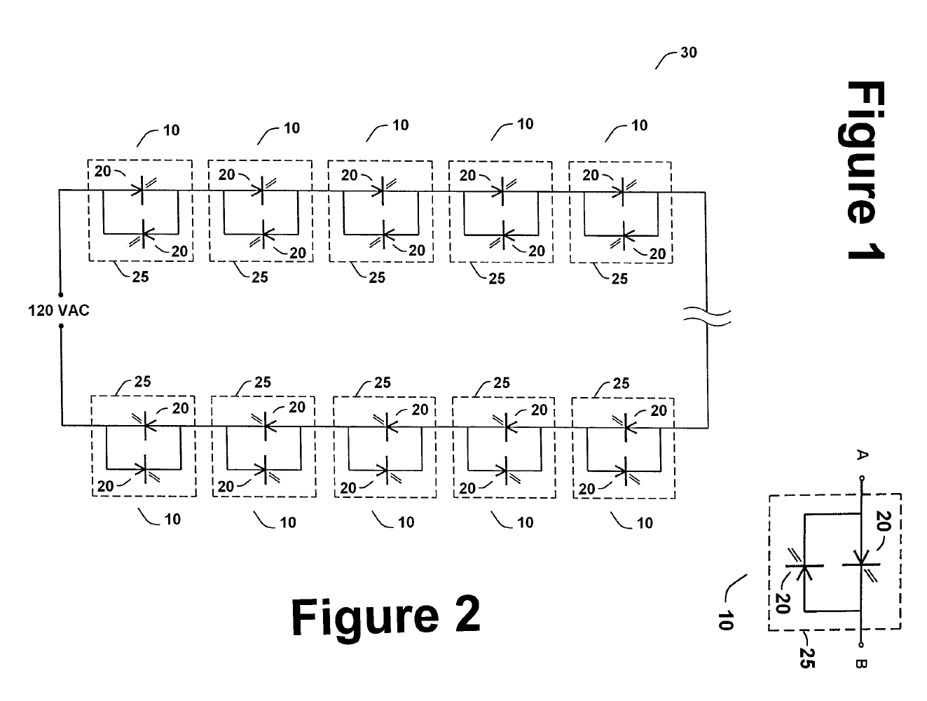

FIG. 1 shows a circuit schematic of an exemplary bi-polar same-color LED device 10. The device 10 comprises at least a pair of substantially same-color light emitting diodes 20 connected in inverse parallel (connected in parallel but in opposite polarity directions). The light emitting diodes 20 are preferably on side-by side chips contained within the same encapsulant or housing 25. Alternatively the light emitting diodes 20 could be on the same chip within a single encapsulant 25, or they could be deployed as discrete units. Unlike multi-color bi-polar LEDs available with chips illumination two different colors, both light emitting diodes 20 for a device 10 radiate the same color. The device 10 also preferably has substantially the same electrical properties in both polar directions, unlike multi-color bi-polar LEDs for which electrical properties may be different in each direction.

Preferably the light emitting diodes 20 comprising an LED device 10 will be from the same manufacturer and of the same make and construction with the same electrical specifications. Like LED devices 10 preferably are fabricated with electrically similar operational requirements such as voltage and current ratings for use in a light string.

The device 10 has terminals A and B as shown in FIG. 1, across which the device 10 may be powered by an AC supply voltage matching the AC voltage rating of the device 10. The AC voltage ratings are typically between 1.5-3.5 VAC RMS for presently available light emitting diodes. For example, a supply voltage of 3.5 VAC RMS could be used for a device 10 with light emitting diodes 20 emitting white light. A typical supply voltage of 2.0 VAC RMS could be used for a device 10 with light emitting diodes 20 emitting red light.

An advantage of bi-polar same-color LED devices 10 is that due to their bidirectional symmetry there is no need to ensure that they are oriented in one direction or another to properly operate in a light string. There is thus no need to provide a lamp holder or socket with a notch, keyed-offset or other mechanical expedient to ensure a correct polarity orientation for LED insertion in a light string light during manufacturing or LED replacement by a user, as taught in U.S. Pat. No. 6,461,019. Another advantage is that the LED devices 10 can use both halves of the AC alternating current cycle and thus burn brighter than a single light emitting diode that just operates on half of the AC current cycle. Still another advantage is that if one light emitting diode 20 fails the device 10 can continue to operate using the remaining light emitting diode 20. Due to human perceptions of brightness, loss of one light emitting diode 20 (fifty percent luminosity reduction) would typically result in less than a fifty percent brightness reduction perceived by the human eye.

FIG. 2 shows a circuit schematic of bi-polar same-color LED devices 10 in a series-wired block in an AC powered light string 30. The sum of the AC voltage ratings (e.g., VAC RMS values) for each of the devices 10 would typically be matched to the effective AC supply voltage for the string 30 (e.g., 120-125 VAC RMS). For example, thirty-five series-wired 3.5 VAC RMS LED devices 10 could be used in a 120-125 VAC string 30. Light strings 30 with LED devices 10 operating at 3 VAC RMS each could use 40 LED devices 10. With 2.4-2.5 VAC RMS LED devices 10, a string 30 could have 50 bi-polar LED devices 10. An all red string 30 of 2.0 VAC RMS LED devices 10 could have 60 bi-polar LED devices 10.

Multi-color series-wired LED light strings 30 can be made employing different colored bi-polar same-color LED devices 10, each preferably having a pair of light emitting diodes 20 of the same color and type. LED devices 10 could have different AC voltage ratings in such a light string 30, but the sum of the AC rated voltages for each of the devices 10 would generally match the effective AC supply voltage for the string 30.

The number of bi-polar LED devices 10 in a series-wired 120-125 VAC powered series block would generally be approximately thirty to sixty or more depending upon the types and colors of LEDs used, using presently available light emitting diodes. A light string 30 could comprise a single series block as shown in FIG. 2, or multiple such series blocks connected in parallel (series-parallel LED device 10 interconnections). Further, light strings 30 can be conventionally wired for multiple strings to be connected end to end, with lighting elements in each string collectively coupled in parallel with those in other strings.

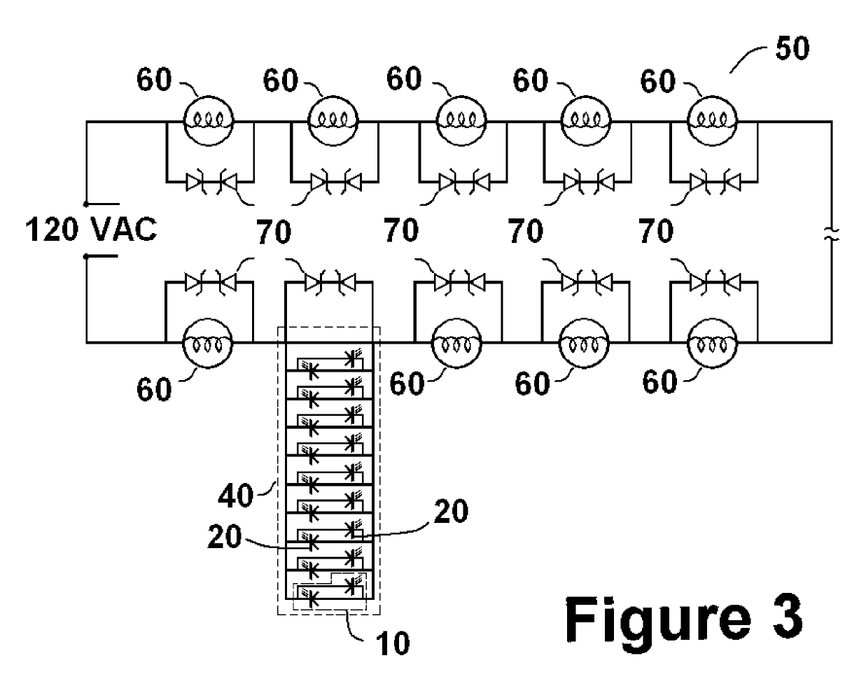

FIG. 3 shows a circuit schematic of bi-polar same-color LED devices 10 in a parallel block 40 in series with other lighting elements (parallel-series LED device 10 interconnections) in an AC powered light string 50. In this example, the light string 50 comprises series-wired incandescent mini-lights 60 as are used in available standard StayLit® type light strings. Across each mini-light 60 is a back-to back Zener diode shunt 70 that allows the light string 50 to continue to function even though one ore more mini-lights 60 are inoperative, poorly connected or missing from their respective sockets.

In the example show in FIG. 3, the parallel block 40 is preferably constructed so that its overall AC voltage and current ratings match that of each of the other series-wired lighting elements (mini-lights 60) in the light string 50. This allows a parallel block 40 to effectively be substituted for one or more of the other series-wired lighting elements. As illustratively shown, the parallel block 40 of bi-polar same-color LED devices 10 is connected in series with the other lighting elements—mini-lights 60—in the light string 50. In this example, assuming a 20 ma AC current rating for each LED device 10, the total operational current through the illustrated block 40 of ten LED devices 10 is 200 ma, which is approximately the same as the AC current rating typical for each of the mini-lights 60.

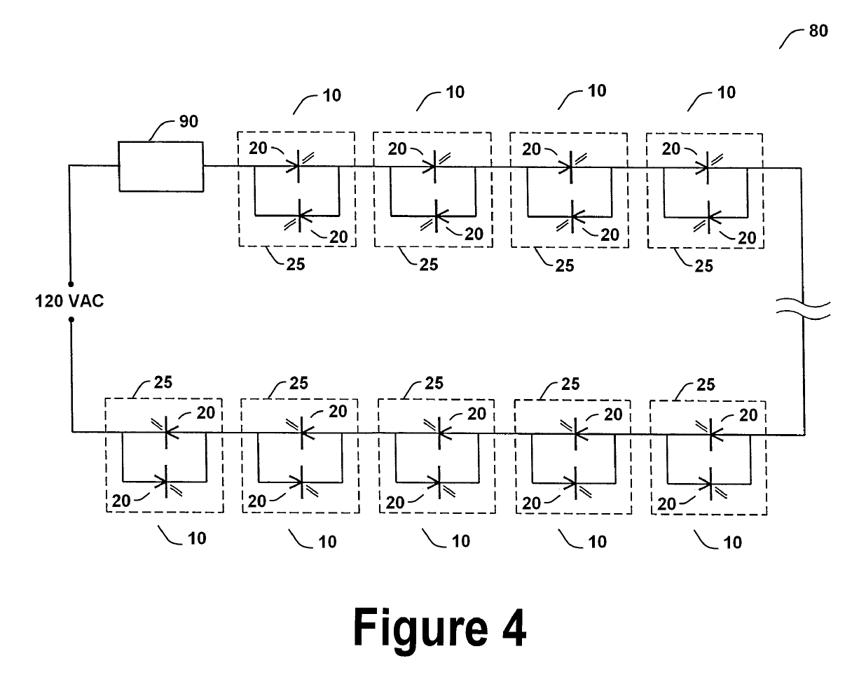

FIG. 4 shows a circuit schematic of bi-polar same-color LED devices 10 in a series-wired block in an AC powered light string 80 with exemplary optional current limiting circuitry 90. The current limiting circuitry 90 could be used to help provide an operationally stable light string 80 using a reduced number of LED devices 10. The AC voltage and current ratings of the current limiting circuitry 90 would depend upon or determine the number and arrangement of LED devices 10 in the light string 80. The current limiting circuitry 90 is preferably a varistor or thermistor, but could be a resistor, inductor or capacitor, back to back Zener diodes, or a combination of such elements. The particular arrangement of the current limiting circuitry 90 or its components is not critical so long as the current through the LED devices 10 is limited by the circuitry or components.

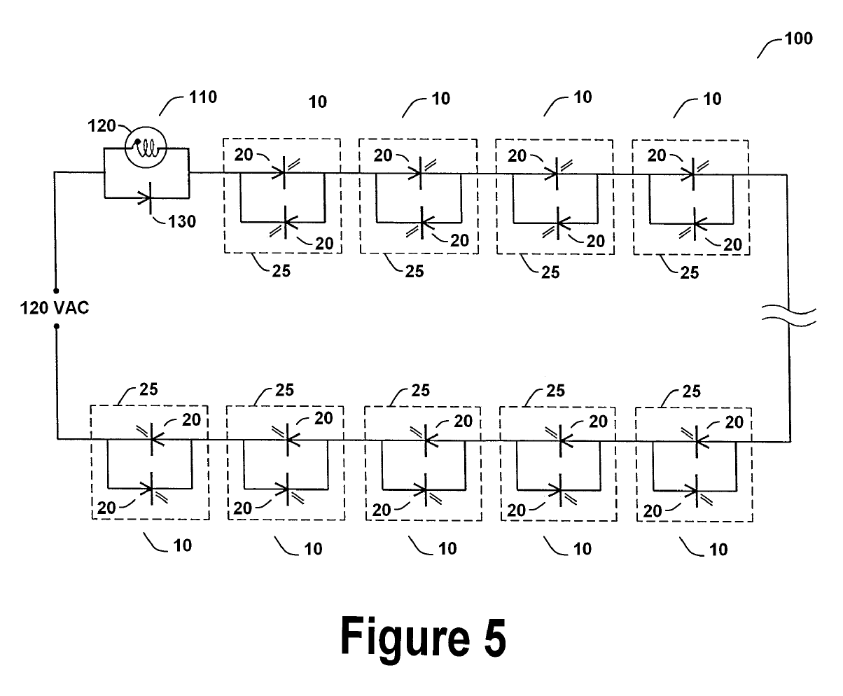

FIG. 5 illustrates a further example of current limiting circuitry used with bi-polar same-color LED devices 10 in a series-wired block in an AC powered light string 100. In this case the current limiting circuitry comprises an incandescent flasher bulb device 110 having an incandescent flasher bulb 120 and a silicon diode 130, achieving a bright-dim effect. When power is first applied, current illuminates the flasher bulb 120, bypassing diode 130 on one-half of the AC cycle and allowing for high brightness of the bi-polar LED devices 10 in the series-wired string 100. Current through the LED devices 10 is, however, limited by the voltage drop across the flasher device 110. When the flasher bulb 120 extinguishes, the diode 130 limits the current by only allowing current to flow during one-half of each AC power cycle. This condition results in the LED devices 10 exhibiting a dimmer light output since only the forward biased light emitting diodes 20 can illuminate. When the flasher bulb 120 comes on again, current flows during both halves of each AC power cycle, allowing again for full illumination of all light emitting diodes 20 in the light string 100. The incandescent flasher bulb device 110 is a low cost way to generate a bright-dim illumination of the light emitting diodes 20 in the series-wired light string 100 using bi-polar same-color LED devices 10.

The invention can be carried out as described in examples above and also in many other embodiments not specifically described here. A very wide variety of embodiments is thus possible and is also within the scope of the following appended claims.

What is claimed is:

1. A bi-polar same-color LED device comprising at least a pair of substantially same-color light emitting diodes connected in inverse parallel.

2. The bi-polar same-color LED device of claim 1 in which said light emitting diodes are in a common encapsulant.

3. A light string comprising a plurality of bi-polar same-color LED devices connected in series, each of said bi-polar LED devices having at least a pair of substantially same-color light emitting diodes connected in inverse parallel.

4. The light string of claim 3 in which said light string is AC powered.

5. The light string of claim 4 further comprising circuitry limiting current through said LED devices.

6. The AC powered light string of claim 5 in which said circuitry comprises a varistor connected in series with said LED devices.

7. The AC powered light string of claim 5 in which said circuitry comprises a resistor connected in series with said LED devices.

8. The AC powered light string of claim 5 in which said circuitry comprises an inductor connected in series with said LED devices.

9. The AC powered light string of claim 5 in which said circuitry comprises a capacitor connected in series with said LED devices.

10. The AC powered light string of claim 5 in which said circuitry comprises a thermistor connected in series with said LED devices.

11. The AC powered light string of claim 5 in which said circuitry comprises an incandescent flasher bulb device connected in series with said LED devices.

12. The AC powered light string of claim 11 in which said incandescent flasher bulb device comprises a diode in parallel with an incandescent flasher bulb.

13. The AC powered light string of claim 5 in which at least two of said bi-polar same-color LED devices are of different colors in the light string.

14. The AC powered light string of claim 5 powered by 120 VAC (RMS) and having approximately 35 3.5 VAC (RMS) bi-polar LED devices in series.

15. The AC powered light string of claim 5 powered by 120 VAC (RMS) and having approximately 50 2.4 VAC (RMS) bi-polar LED devices in series.

16. The AC powered light string of claim 5 powered by 120 VAC (RMS) and having approximately 60 2 VAC (RMS) bi-polar LED devices in series.

17. An AC powered light string comprising a plurality of bi-polar same-color LED devices connected in a parallel block, said parallel block being connected in series with other lighting elements in said light string.

18. A bi-polar LED device with substantially the same color properties in both polarity directions.

19. The bi-polar LED device of claim 18 having at least a pair of substantially same-color light emitting diode chips connected in inverse parallel.

20. The bi-polar same-color LED device of claim 18 having at least a pair of discrete substantially same-color light emitting diodes connected in inverse parallel.
